(19) United States
(12) Patent Application Publication
(10) Pub. No.: US 2007/0169389 A1
(43) Pub. Date: Jul. 26, 2007

(54) License plate magnet

(76) Inventor: Allan M. Hoffman, Cincinnati, OH (US)

Correspondence Address: Allan M. Hoffman, 34 W. CRESCENTVILLE RD, CINCINNATI, OH, 45246, US

(21) Appl. No.: 11/656,918

(22) Filed: Jan. 23, 2007

Related U.S. Application Data
(60) Provisional application No. 60/762,175, filed on Jan. 25, 2006.

(51) Int. Cl. G09F 7/00

(52) U.S. Cl. 40/209

(57) ABSTRACT

A license plate magnet consisting of a plurality of magnets attached to a flexible backing covered with a protective polyolefin coating to provide maximum protection to vehicles finish. As portions of today's automobiles are frequently made from lightweight plastics instead of steel and often numerous plastics panels block access to the remaining steel, compounded by ultra-curved designs, the old flat magnet no longer can find a location for use. Hence, an improved flexible design makes greater contact to the convex surface and can be placed above rear window where almost all automobiles still have steel or on other areas for a quick, safe display of license plates.

This Application claims the benefit of the filing date of Provisional Application # 60/762,175 filed on Jan. 25, 2006 as the priority date for this non-provisional application.

### REFERENCES CITED

U.S. PATENT DOCUMENTS

| | | | |
|---|---|---|---|
| 3,230,635 | September 1963 | Rice | 40/129 |
| 3,430,376 | March 1969 | Drybread Sr. | 40/209 |
| 4,287,676 | September 1981 | Weinhaus | 40/10 |
| 5,386,960 | February 1995 | O'Brien | 248/205.5 |
| 5,997,679 | February 1999 | Wheat | 156/244.11 |

### BACKGROUND OF THE INVENTION

Since automobiles have been sold, there have been very few devices designed for the purpose of displaying license plates to enable potential buyers to drive using the automobile dealers state issued license plate quickly, safely and legally for test drives. Not any of the above referenced disclosures represent the answer to the auto dealer's need of an inexpensive readily available yet failsafe method for affixing license tag quickly to automobile so that potential buyer can test drive vehicles.

The invention by O'Brien would be an option. It calls for license plates to be attached to rear window with the use of suction cups. It seems to have never been marketed and is unavailable, but if it was, it would certainly restrict vision out of the rear window, and suction cups seem to fail quickly, especially in the cold, and leave messy marks on glass. Another procedure is to place license in rear window by wedging it between deck and glass which also restricts vision out of rear glass and frequently falls down before test drive is over.

Another possibility by Drybread Sr. is to attach plate to a product made from rubber which encases the entire license plate except the front portion. The license plate is then bolted to device. It also has two thick rubber tangs that are a little over an inch wide by about six inches long by 3/16ths thick (1″×6″× 3/16″). At the halfway point and at the end opposite the license plate there are protrusions measuring about ¾ of an inch radius by slightly less than ¼ inch thick. Thus, at the location of the tangs there is a thickness of very close to half an inch. These are placed there to keep the device from sliding when these extensions are slammed in between body and trunk or rear hatch. This device also brings with it many problems. It flops around often hitting the bumper and sometimes the nuts or bolts to which it affixes to license plate cause scratches. Today's low tolerance gaps cannot handle a one quarter to half inch piece slammed into the trunk thus the thin steel is often dented while trying to slam deck lid in an attempt to keep it closed. Best case, it often does work, but it triggers the warning light on the dash that warns driver that the trunk or hatch is open! Some dealers try to place the unit sideways, perpendicular to bumper, along side of tail light which has been known to cause lamp lenses to crack.

The most common prior art and old standby which has been used for decades is magnets. They are normally high energy ceramic magnets glued in a one inch tall by eight inches long by one half inch thick (1″×8″×½″) by 8″ solid steel channel. They are either coated with a rubber like material or tape. For many reasons, either the lack of the materials ability to accept electro-coating due to its insulating non-conductive quality by nature and/or the steel edge by nature gaining most of the magnetic force pulling steel to steel; their coating always cracks and falls off and the steel corner scratches the finish of automobile. To deal with this most auto dealers cover their magnets with a soft tape such as duct tape which weakens the device. Another problem arises with today's automobiles basic design. There are often no flat steel spots to place yesterday's magnet, enabling less than an inch of the old flat magnet to actually contact the vehicle which causes device to rock and fall off car.

Another attempt to aid the automobile dealer was done by Rice. He used a backing plate made from a channel of non-flexible steel glued to a piece of flexible and resilient magnetic material to hold onto. car magnetically. The nature of that compound, and only the flexible rubberized magnetic material contacting the vehicles painted surface was valid, but rubberized magnetic material has far less force causing much weaker pull than the above mentioned old standby or our improved device. The Rice device would keep scratches for occurring but won't work on today's curvy cars because of its lack of flexibility.

The Weinhaus patent claims to teach us about coefficient of friction in magnetic securement. He explains that items secured by magnets embedded or molded into particular types of plastics or rubbers are less likely to slide due to gravity and movement. He gains validity with graphs and charts and shows how high lateral adherence is raised by coating the cheaper and more readily available ceramic magnets. He also teaches of the benefits of elastomeric coverings as a protection from scratching. Weinhaus relates his invention to items for various uses such as on refrigerators, appliances, cabinets for hanging items like charts, shopping lists etc. as well as other uses but differs for numerous reasons.
a. He does not directly state or come up with a valid use for auto dealer to display license tags.
b. Our invention creates a device wherein the elastomeric material is made from a heat shrink tubing made from Polyolefin which is produced from using thin layers of isotactic polymers, as patented by Wheat. The Weinhaus patent states use of polyvinyl chloride, polyvinyl butyral, and vulcanized silicone rubber. Our Polyolefin is shrunk by use of heat to form to our device. It acts to increase the coefficient of friction, protect surface of vehicle from scratches, acts to hold entire unit together, and allows individual magnets to move independently.
c. By nature of the amazing magnetic force produced by our particular construction there is a need for our assembly to be placed onto automobile by tipping preferably touching the upper edge of unit first at an angle of about 45 degrees, and then roll the rest of the magnetic portion into contact with the steel. Likewise removal needs to occur in the reverse manner, or even better, by the use of peeling, by pulling outward on both sides of plate, simultaneously and carefully.
d. The gap between the license plate and vehicle is thick enough to get ones fingers behind it, at least one half (½) an inch thick including a spacer to insure safe removal from the rear of automobile.
e. Our design calls for a spacer (FIG. 2 number 7), such as a washer or plurality of washers to be placed between the license plate and our unit. This washer, washers, spacers become paramount in providing flexibility to the assembly once backing plate and license plate are bolted together. Without the spacer unit would be stiff and the flexibility for our individual magnets to mate entirely, would be lost on a convex surface.

The inventor has worked in the automotive retail field for well over two decades. The hassles involved with getting potential buyers quickly out on the road is something he has experienced first hand. Many other auto dealers have tested this new magnetic device, and some have called back for more with rave reviews. One sales manager has purchased thirty over a period of just a few months! This rather simple device clearly will be put to use on a massive scale, and won't just end up another number in the USPTO archives.

### BRIEF SUMMARY OF INVENTION

The Improved License Plate Magnet is the answer to the conundrum which faces every auto dealer and salesman who goes out on test drives. Except for the Corvette, almost every mass production automobile made in or entering the U.S. for retail sale has a location visible from the rear that will grab hold on and accept our modem device.

This invention includes a flexible backing plate which can either be made out of steel or any other material such as acrylic, pvc, etc. as long as plate can flex as well as be attached to license plate by use of screw, nuts, rivets, clamps or other devices. It also includes a plurality of magnets which can be round, square, rectangular, oblong, or any shape and these permanent magnets can be made from ceramic or ferrite, neodymium iron boron (NdFeB-rare earth), alnico, or samarium cobalt (SmCo) or any other magnets as long as they can be attached to flexible backing and including flexible magnetic material which on its own can act as both magnet as well as backing. This invention includes the use of a spacer, washer or multiples thereof to be placed between the backing plate of the unit and the license plate to help aid in the flexibility of the assembly.

This invention includes the use of flexible Polyolefin heat shrink tubing which encases the magnets as well as the backing, and when heat is applied acts as a cover and holds everything together. This enables enveloped magnets to slide so that unit can curve to a concave or convex surface and also leaves a relatively soft and scratch resistant surface to mate with finish on automobile. This, relatively inexpensive, powerful yet scratch resistant design, is what dealers have needed, to help get their potential buyers out from their lots onto test drives quickly in todays fast pace purchase world. License Plates in all 50 States are relatively the same size with holes for attaching to vehicles spaced at the same distance.

### BRIEF DESCRIPTION OF DRAWNGS

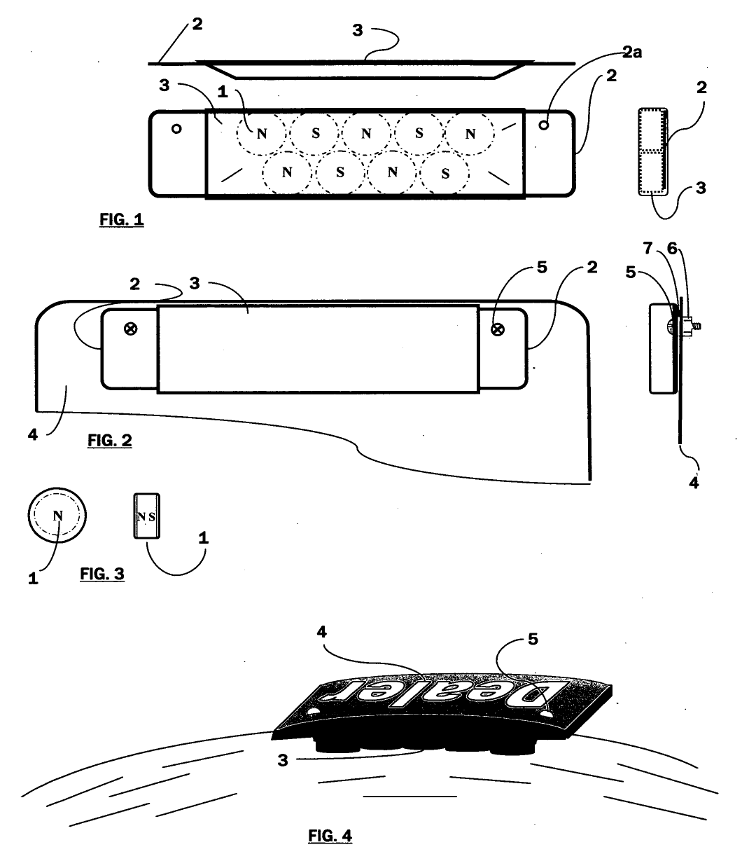

FIG. 1 is a perspective view of invention showing placement of magnets under Polyolefin heat shrink cover.

FIG. 2 is a perspective view of device as attached to license plate showing nuts and bolts.

FIG. 3 is a perspective view of individual magnets that comprise unit.

FIG. 4 is a rear view of what is becoming more common in today's vehicle. As shown, the license plate can only find steel which is slightly convex in nature.

### DETAILED DESCRIPTION OF THE INVENTION

Individual magnets 1 are located as shown on one side of a relatively thin mild steel plate 2 with holes 2A to line up with holes in a standard USA license plate issued by all 50 States. Elastomeric cover 3 made from Polyolefin heat shrinkable tubing 3 holds the magnets 1 in place and provides a relatively soft surface to contact the vehicle to protect the finish as well providing a high coefficient of friction so that the license plate can't slip on the vehicle. Two bolts 5 with nuts 6 hold the magnet assembly to the license plate 4. Washers 7 or (multiples thereof or spacers) are used between the license plate 4 and the steel plate 2 so the magnet assembly can bend independently and in conjunction with the license plate 4. This enables the entire group of magnets to mate relatively perfectly whether the automotive surface is convex or concave, in any direction. FIG. 3 shows the manner in which each individual magnet is magnetized, being through the thickness with the poles on the faces. Magnets are laid out accordance to polarity shown in FIG. 1 but not limited to this particular shape or pattern. FIG. 4 shows a rear portion of todays automobile. The old magnet finds no area to lock onto except for above rear window as shown. The new license plate magnet assembly curves along with the curved portion of automobiles top and holds on at high speeds on bumpy roads.

What I claim is:

1. A magnetic license plate assembly comprising of a flexible plate, a plurality of individual magnets, a mechanical means for mounting flexible plate to license plate, and an elastomeric polyolefin heat shrinkable covering.

2. A magnetic license plate assembly of claim 1 wherein flexible plate is magnetic steel.

3. A magnetic license plate assembly of claim 1 wherein means of fastening is provided by use of holes in flexible plate lining up with holes of license plate.
